(19) United States
(12) Patent Application Publication
(10) Pub. No.: US 2026/0003484 A1
(43) Pub. Date: Jan. 1, 2026

(54) OBJECT PROCESSING METHOD AND APPARATUS, ELECTRONIC DEVICE AND READABLE STORAGE MEDIUM

(71) Applicant: GUANGDONG OPPO MOBILE TELECOMMUNICATIONS CORP., LTD., Dongguan (CN)

(72) Inventors: Dingxuan WANG, Dongguan (CN); Jun ZHANG, Dongguan (CN); Boyu MO, Dongguan (CN)

(73) Assignee: GUANGDONG OPPO MOBILE TELECOMMUNICATIONS CORP., LTD., Dongguan (CN)

(21) Appl. No.: 19/197,501

(22) Filed: May 2, 2025

Related U.S. Application Data
(63) Continuation of application No. PCT/CN2023/117306, filed on Sep. 6, 2023.

(30) Foreign Application Priority Data
Nov. 4, 2022 (CN) 202211378082.4

(51) Int. Cl. G06F 3/04845; G06F 3/0486

(52) U.S. Cl. CPC G06F 3/04845; G06F 3/0486

(57) ABSTRACT

An object processing method is performed by an electronic device and includes: displaying a first processing interface, the first processing interface displaying a target object; obtaining at least one application configured to process the target object, and displaying an identifier of each of the at least one application in the first processing interface; sequentially selecting at least one application from the at least one application and processing a corresponding to-be-processed object by each currently-selected application to obtain an object processing result after at least one processing. The to-be-processed object corresponding to an application that is firstly selected from the at least one application is the target object; the to-be-processed object corresponding to an application that is not firstly selected from the at least one application is an object obtained after processing the target object for at least once.

### CROSS REFERENCE TO RELATED APPLICATIONS

The present application claims the priority of the Chinese patent application No. 202211378082.4, filed on Nov. 4, 2022, contents of which are incorporated herein by its entireties.

### TECHNICAL FIELD

Embodiments of the present disclosure relate to the technical field of computers, and more specifically, to an object processing method, an apparatus, an electronic device, and a computer-readable storage medium.

### BACKGROUND

As technologies of electronic devices develop, an electronic device may obtain an object edit the obtained object. For example, the object obtained by the electronic device may be an image or a text. In some cases, in a process of processing the object, a plurality of applications may be used for processing the object. However, in a process of using at least one application to process the object, a user may perform operations inconveniently, and therefore, convenience of operation needs to be improved.

### SUMMARY

The present disclosure provides an object processing method, an apparatus, an electronic device, and a computer-readable storage medium, so as to solve the technical problems in the above.

In a first aspect, an object processing method is provided and is performed by an electronic device, the method includes:
displaying a first processing interface, wherein the first processing interface displays a target object; obtaining at least one application configured to process the target object, and displaying an identifier of each of the at least one application in the first processing interface; sequentially selecting at least one application from the at least one application and processing a corresponding to-be-processed object by each currently-selected application to obtain an object processing result after at least one processing; wherein the to-be-processed object corresponding to an application that is firstly selected from the at least one application is the target object; the to-be-processed object corresponding to an application that is not firstly selected from the at least one application is an object obtained after processing the target object for at least once.

In a second aspect, an object processing apparatus is configured to be run in an electronic device, the object processing apparatus includes:
an editing interface display unit, configured to display a first processing interface, wherein the first processing interface displays a target object; an application selection unit, configured to obtain at least one application configured to process the target object, and display an identifier of each of the at least one application in the first processing interface; an object processing unit, configured to sequentially select at least one application from the at least one application and takes each currently-selected application to process a corresponding to-be-processed object to obtain an object processing result after performing at least one processing; wherein the to-be-processed object corresponding to an application that is firstly selected from the at least one application is the target object; the to-be-processed object corresponding to an application that is not firstly selected from the at least one application is an object obtained after the target object being processed for at least once.

In a third aspect, an electronic device is provided and includes: one or more processors and a memory; wherein one or more programs are stored in the memory and are configured to be executed by the one or more processors to perform the method in the above.

In a fourth aspect, a computer-readable storage medium is provided and has program codes stored therein. The program codes are configured to be run by a processor to perform the method in the above.

### BRIEF DESCRIPTION OF THE DRAWINGS

In order to more clearly illustrate technical solutions in embodiments of the present disclosure, accompanying drawings used in the embodiments will be briefly introduced below. Obviously, the accompanying drawings in the following description show only some of the embodiments of the present disclosure, and any ordinary skilled person in the art may obtain other accompanying drawings based on these drawings without creative work.

FIG. 1 is a flow chart of an object processing method according to an embodiment of the present disclosure.

FIG. 2 is a schematic view of a selection interface of an application according to an embodiment of the present disclosure.

FIG. 3 is a schematic view of a displaying interface of a target object according to an embodiment of the present disclosure.

FIG. 4 is a schematic view of a second processing interface according to an embodiment of the present disclosure.

FIG. 5 is a schematic view of a first processing interface according to an embodiment of the present disclosure.

FIG. 6 is a schematic view of a selection interface of a first application according to an embodiment of the present disclosure.

FIG. 7 is a schematic view of a selection interface of a second application according to an embodiment of the present disclosure.

FIG. 8 is a schematic view of another selection interface of the second application according to an embodiment of the present disclosure.

FIG. 9 is a flow chart of the object processing method according to another embodiment of the present disclosure.

FIG. 10 is a schematic view of an application interface according to an embodiment of the present disclosure.

FIG. 11 is a flow chart of the object processing method according to still another embodiment of the present disclosure.

FIG. 12 is a flow chart of the object processing method according to still another embodiment of the present disclosure.

FIG. 13 is a schematic view of displaying a plurality of post-processed objects that are stacked according to an embodiment of the present disclosure.

FIG. 14 is a schematic view of a dragging operation according to an embodiment of the present disclosure.

FIG. 15 is a schematic view of displaying a plurality of post-processed objects that are arranged side by side according to an embodiment of the present disclosure.

FIG. 16 is a schematic view of displaying a plurality of post-processed objects that are arranged side by side according to an embodiment of the present disclosure.

FIG. 17 is a structural schematic diagram of an object processing apparatus according to an embodiment of the present disclosure.

FIG. 18 is a structural schematic diagram of an electronic device configured to perform the object processing method according to an embodiment of the present disclosure.

FIG. 19 is a schematic view of a storage unit configured to store or carry program codes of the object processing method according to an embodiment of the present disclosure.

### DETAILED DESCRIPTIONS

The technical solutions in the embodiments of the present disclosure will be described clearly and completely in the following by referring to the accompanying drawings in the embodiments of the present disclosure. Obviously, the described embodiments are only a part of, not all of, the embodiments of the present disclosure. All other embodiments, which are obtained by any ordinary skilled person in the art based on the embodiments in the present disclosure without making creative work, shall fall within the scope of the present disclosure.

As technologies of electronic devices develop, an electronic device may obtain an object edit the obtained object. For example, the object obtained by the electronic device may be an image (a picture or a video), a text, and an audio. In the electronic device, in order to achieve certain demands of a user, the object may be processed for a plurality of times, and the plurality of times of processing may be performed by a plurality of different applications. For example, when the object is the image, in order to enable the image to have a displaying style desired by the user, a plurality of applications may be invoked to process the image.

However, the inventor found that, during processing the object by the plurality of applications, the user may perform operations inconveniently, such that the user experience needs to be improved. For example, during processing the image, the plurality of applications may be distributed at a plurality of locations of the electronic device, such that the user needs to operate the electronic device to switch between various interfaces (such as, a desktop) to select the plurality of applications, therefore, the operations are inconvenient.

Therefore, in order to solve the above-described problem, an object processing method, an apparatus, an electronic device, and a computer-readable storage medium are provided. After displaying a first processing interface including a target object, at least one application for processing the target object may be obtained, and an identifier of each of the at least one application may be displayed in a first processing interface. Subsequently, the at least one application may be selected one by one, a corresponding to-be-processed object may be processed by a currently-selected application, such that an object processing result may be obtained after performing at least one processing. In this way, in the case that the target object needs to be processed by at least one application, the at least one application corresponding to the target object can be collected firstly and may be collectively displayed directly on the first processing interface. In this way, the user may select a desired application on the first processing interface to process the target object or the to-be-processed object. Operations of switching between application-displaying interfaces to select a plurality of applications in the electronic device may be avoided, the user may perform the operations more conveniently, ease of operations may be improved.

The present disclosure provides an object processing method, performed by an electronic device, the method includes the following.

A first processing interface may be displayed. The first processing interface may display a target object. At least one application for processing the target object may be obtained. An identifier of each of the at least one application may be displayed in the first processing interface. At least one application may be selected sequentially from the at least one application, and a corresponding to-be-processed object may be processed by a currently-selected application. An object processing result may be obtained after at least one processing. The to-be-processed object corresponding to one of the at least one application that is selected firstly may be the target object. The to-be-processed object corresponding to any one of the at least one application that is not selected firstly may be an object obtained after processing the target object for at least once.

In some embodiments, the operation of selecting the at least one application sequentially, and processing the corresponding to-be-processed object by the currently-selected application, obtaining the object processing result after at least one processing, includes: obtaining the currently-selected application from the at least one application; displaying an application interface of the currently-selected application; processing the to-be-processed object corresponding to the currently-selected application through the application interface; and performing a next application selection after completing the processing the to-be-processed object, until obtaining the object processing result.

In some embodiments, the operation of displaying the application interface of the currently-selected application includes: switching from displaying the first processing interface to displaying the application interface of the currently-selected application. The operation of performing the next application selection after completing the processing the to-be-processed object includes: after completing the processing the to-be-processed object, switching from displaying the application interface to displaying the first processing interface to perform the next application selection.

In some embodiments, the method further includes: determining that the processing the to-be-processed object is completed, in response to an export operation performed on the application interface. The export operation may be performed to save an object that is processed through the application interface to the electronic device.

In some embodiments, the operation of obtaining the at least one application for processing the target object includes: obtaining at least one application for processing the target object and a processing sequence in which a plurality of applications perform processing. The to-be-processed object corresponding to the application that is not firstly selected may be an object output by an application that performs processing before the instantly-selected application according to the processing sequence.

In some embodiments, the operation of obtaining at least one application for processing the target object and the processing sequence in which the plurality of applications perform processing includes: displaying a first application selection interface in response to a first trigger operation performed on the first processing interface, the first application selection interface displaying to-be-selected applications; obtaining a plurality of applications selected from the to-be-selected applications as the at least one application corresponding to the target object; using a selection sequence in which the plurality of applications are selected in the first application selection interface as the processing sequence corresponding to the plurality of applications.

In some embodiments, the operation of obtaining at least one application for processing the target object includes: displaying, in response to a second trigger operation performed on the first processing interface, a second application selection interface in which a plurality of application combinations are displayed; taking a plurality of applications included in a selected application combination of the plurality of application combinations as the at least one application corresponding to the target object.

In some embodiments, the method further includes: generating the plurality of application combinations based on past selection performed on applications or based on a processing content corresponding to the target object.

In some embodiments, the method further includes: displaying an application scenario in which each of the plurality of application combinations applies.

In some embodiments, the operation of displaying the identifier of each of the at least one application in the first processing interface includes: displaying the at least one application in the first processing interface based on the processing sequence in which the at least one application processes the target object.

In some embodiments, an object type of the target object may be an image, the method further includes: displaying a post-processed object obtained each time after the selected application processes the corresponding to-be-processed object.

In some embodiments, the at least one application for processing the target object may be a plurality of applications, the plurality of applications correspond to a processing sequence, and the operation of displaying the post-processed object obtained each time after the selected application processes the corresponding to-be-processed object includes: displaying, in a stacked manner, post-processed objects obtained after all selected applications processing corresponding to-be-processed objects. A post-processed objected output from an application performing the processing at a later stage may be located at an upper layer of a post-processed objected output from an application performing the processing at an earlier stage.

In some embodiments, the method further includes: when a dragging operation performed on the post-processed object is detected and the dragging operation satisfies a target condition, displaying, side by side, the post-processed object receiving the dragging operation and the post-processed object that is generated earlier; displaying an enlarged icon of the first application and an enlarged icon of the second application. The first application may be an application that outputs the post-processed object receiving the dragging operation. The second application may be an application that outputs the post-processed object generated earlier.

In some embodiments, the operation of displaying the first processing interface includes: displaying objects in an object collection; obtaining an object selected from the object collection as a target image and displaying a target object displaying interface corresponding to the target object; and displaying the first processing interface by performing an interface startup operation performed on the target object displaying interface.

In some embodiments, the operation of displaying the first processing interface includes: displaying the first processing interface including an object adding control; when a click operation performed on the object adding control is detected, displaying an object selection interface, the object selection interface displaying a to-be-selected object; obtaining a target object selected from the object selection interface and displaying the selected target object in the first processing interface.

In some embodiments, the object type of the target object is an image, and an object type of the to-be-processed object is an image.

In some embodiments, the object type of the target object is a text or an audio.

Various embodiments of the present disclosure will be specifically described below by referring to the accompanying drawings.

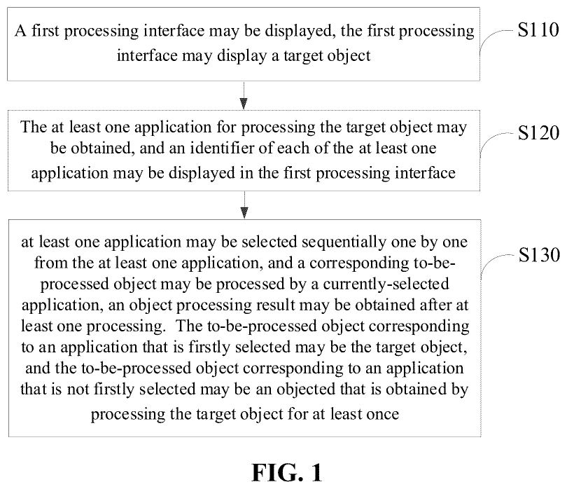

As shown in FIG. 1, the present disclosure provides an object processing method performed by an electronic device, the method includes the following.

In an operation S110, a first processing interface may be displayed, the first processing interface may display a target object.

In the present embodiment, the first processing interface may be an interface for triggering processing of the target object through at least one application. Correspondingly, the target object may be an object that is determined to be processed. A type of the target object may not be specifically limited herein. Any object that can be processed by one or more applications may be taken as a target image of the present disclosure. For example, in the present embodiment, the target object may be an image (a picture or a video), a text, and an audio.

In the present embodiment, displaying of the first processing interface may be triggered in various ways.

In an embodiment, the electronic device may firstly display objects in an object collection, an object may be selected from the object collection as the target image, and a target object displaying interface corresponding to the target object may be displayed. The first processing interface may be displayed by performing an interface startup operation on the target object displaying interface. In some embodiments, a plurality of objects may be included in the object collection, and the plurality of objects may be displayed on a collection displaying interface. In this case, when any object is detected as being clicked, the clicked object may be taken as the target object. Moreover, displaying the target object displaying interface may be triggered in response to the object being clicked. In the case that the objects stored in the object collection are images, the object collection may be a photo album in the electronic device. In the case that the objects stored in the object collection are texts, the object collection may be a folder that stores documents in the electronic device. In the case that the objects stored in the object collection are audios, the object collection may be an audio folder that stores audios in the electronic device.

In the case that the target object displaying interface is displayed, the interface startup operation may be performed on the target object displaying interface to trigger displaying a second processing interface firstly. The first processing interface may then be displayed by performing the interface startup operation performed on the second processing interface. In some embodiments, a touch control may be configured in the second processing interface. The touch control may be configured to trigger displaying the first processing interface. Therefore, when the click operation performed on the touch control is detected, it may be determined that the interface startup operation is performed, and the first processing interface may be displayed.

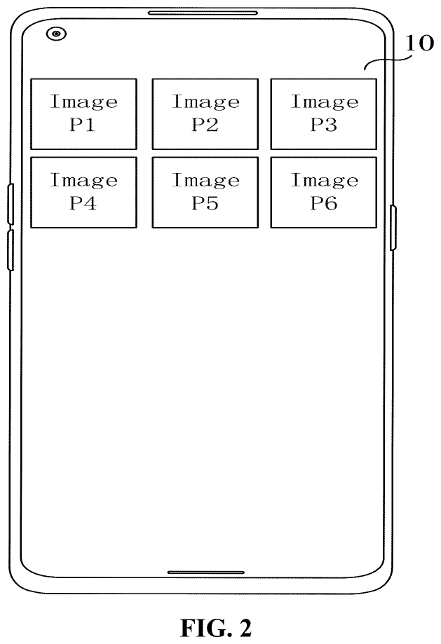

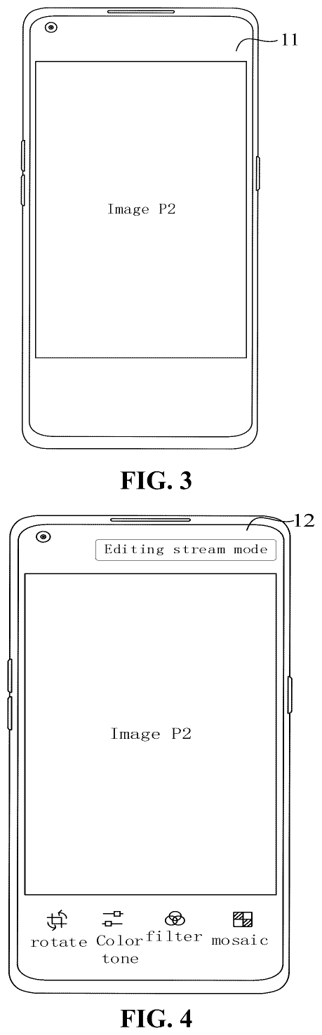

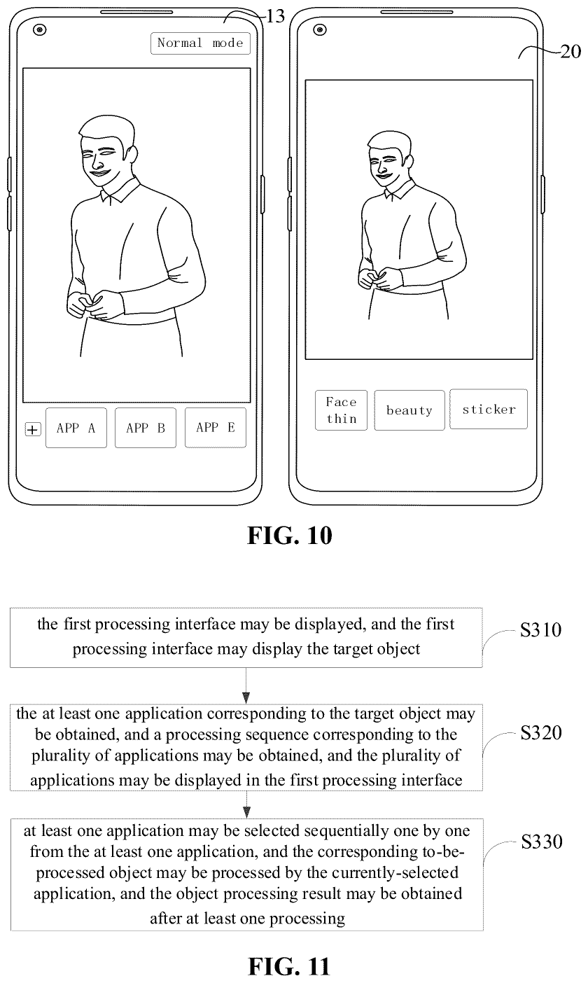

In some embodiments, the object collection may be an image collection (objects in the object collection are stored images). The image collection (such as a photo album in the electronic device) may include a plurality of images. For example, an image P1, an image P2, an image P3, an image P4, an image P5, and an image P6 in the image collection may be displayed in an interface 10 shown in FIG. 2. When a click operation performed on the image P2 is detected, the image P2 may be taken as the target object, and the target object displaying interface 11 as shown in FIG. 3 may be displayed. The target object displaying interface 11 shown in FIG. 3 may display the image P2. A size of the image P2 in the target object displaying interface 11 may be larger a size of the image P2 shown in FIG. 10. The target object displaying interface 11 may further display a touch control named as “Edit”. When an operation performed on the touch control with the name “Edit” is detected, the interface startup operation may be determined as being performed, and the second processing interface 12 shown in FIG. 4 may be displayed. The second processing interface 12 shown in FIG. 4 may display the image P2. The second processing interface 12, may display a touch control with a name “Edit Stream Mode”. When an operation performed on the touch control with the name “Edit Stream Mode” is detected, the interface startup operation may be determined as being performed, and the first processing interface may be displayed.

In the present embodiment, the first processing interface and the second processing interface process the target object in different ways. As shown in FIG. 4, a plurality of editing tools may be displayed in the second processing interface 12, and the image P2, which is the target object, may be processed by the plurality of editing tools. The plurality of editing tools may include a rotation tool, a color adjustment tool, a filter tool, a mosaic tool, and so on. In the first processing interface, the target object may be processed through at least one application in subsequent operations.

In an embodiment, the first processing interface may be displayed directly firstly, and an object adding control may be configured in the displayed first processing interface. When a click operation performed on the object adding control is detected, the object selection interface may be displayed, and to-be-selected objects may be displayed in the object selection interface. In this way, the target object may be selected from the object selection interface, and the selected target object may be displayed in the first processing interface.

It is to be noted that the target object in the present disclosure may be in various types. Target objects in different types may be displayed in different manners. For example, when the target object is the image, a content of the image may be displayed directly when displaying the target object. When the target object is the text, all or part of contents of the text may be displayed directly when displaying the target object. When the target object is the audio, a name of the audio may be displayed directly when displaying the target object.

In an operation S120, the at least one application for processing the target object may be obtained, and an identifier of each of the at least one application may be displayed in the first processing interface.

In an embodiment, the application corresponding to the target object may be understood as an application configured to process the target object. The identifier of the application may be a name or an icon, or both a name and an icon of the application.

In the present disclosure, the at least one application for processing the target object may be obtained in various ways.

In an embodiment, the electronic device may, in response to a first trigger operation performed on the first processing interface, display a first application selection interface. The first application selection interface may display to-be-selected applications. In this way, at least one application may be selected from the to-be-selected applications to serve as the at least one application for processing the target object. It is to be noted that, in this manner, the applications displayed in the first application selection interface may be applications provided by the electronic device that can be used to process the selected target object.

In the present disclosure, using the application to process the target object may be understood as using the application to change contents presented or included in the target object. For example, the target image may be the image. Using the application to process the target image as the target object may be understood as changing a displaying characteristic of the target object, or changing a style of an item in the target object. The displaying characteristics may include a filter and a color tone, and so on. The item in the target object may include a person, a plant, an animal, or a landscape, and the like. For example, a face of the person in the target object may be changed to be thinner by the application. In another example, when the target object is the audio, using the application to process the target audio as the target object may be understood as changing an audio length of the target object, or adding or deleting specified audio contents in the target content. In another example, when the target object is the text, using the application to process the target text as the target object may be understood as changing a language version of the target object, or changing a text content of the target object.

As described in the above, the application may be configured to process the target object, and in some embodiments, the electronic device may determine the to-be-selected applications displayed in the first application selection interface based on the type of the target object. For example, when it is determined that the target object is the image, the to-be-selected applications may be applications configured to process images. When it is determined that the target object is the audio, the to-be-selected applications may be applications configured to process audios. When it is determined that the target object is the text, the to-be-selected applications may be applications configured to process texts.

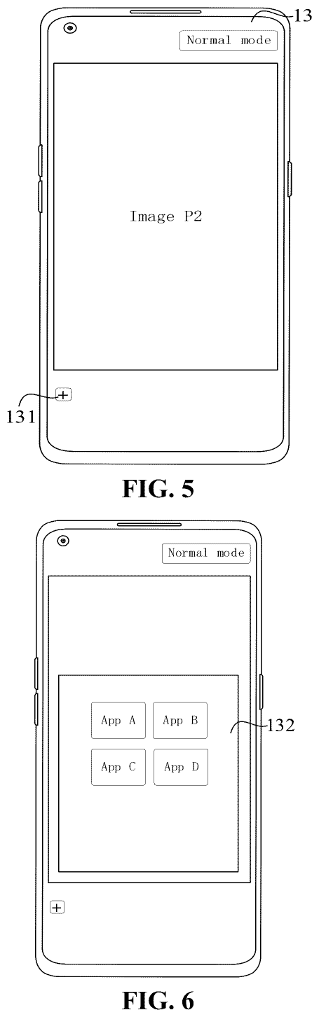

Exemplarily, as shown in FIG. 5, the first processing interface 13 shown in FIG. 5 may be configured with an application adding control 131. When a click operation performed on the application adding control 131 is detected, the first application selection interface 132 shown in FIG. 6 may be displayed. To-be-selected applications displayed in the first application selection interface 132 may include an application A, an application B, an application C, and an application D. When the user selects that the application B and the application C from the first application selection interface 132, then application B and the application C may be used as applications configured to process the target object (such as the image P2).

In another embodiment, the electronic device may, in response to a second trigger operation performed on the first processing interface, display a second application selection interface. The second application selection interface may display a plurality of application combinations. A plurality of applications included in a selected application combination of the plurality of application combinations may be used as the at least one application for processing the target object. In the present embodiment, the user can directly select the application combination instead of selecting each individual application.

Each of the plurality of the application combinations may include a plurality of applications, and the plurality of the application combinations may be generated in various ways.

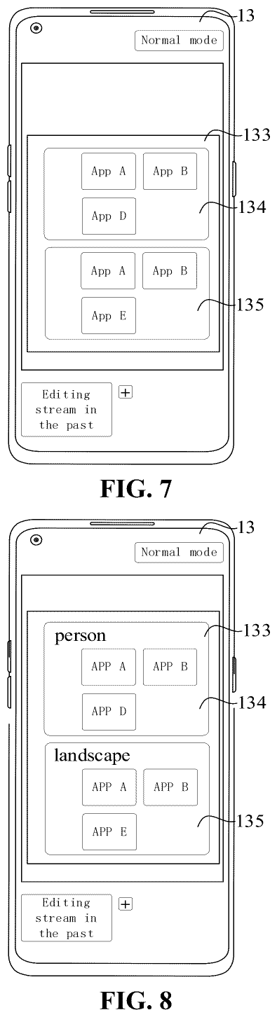

In an embodiment, the plurality of the application combinations may be generated based on past selection of applications. In the present embodiment, the electronic device may record a plurality of applications that were selected in the past by the user and use the plurality of applications selected each time in the past as one application combination. In this way, in the case of displaying the second application selection interface, the plurality of application combinations that are generated based on the past selection may be displayed. Exemplarily, as shown in FIG. 7, a touch control named as “past editing flow” may be displayed in the first processing interface 13. When a click operation performed on the touch control is detected, the second application selection interface 133 may be displayed. The second application selection interface 133 may display an application combination 134 and an application combination 135. When the user selects the application combination 134, the application A, the application B, and the application C may be used as the plurality of applications corresponding to the target object. When the user selects the application combination 135, the application A, the application B, and the application E may be used as the plurality of applications corresponding to the target object.

In some embodiments, in each application combination, an application scenario to which the application combination applies may be shown. For example, as shown in FIG. 8, when the target object is the image, the application scenario to which the application combination 134 may apply may be an application scenario of persons, and the application scenario to which the application combination 135 may apply may be an application scenario of landscapes. The application scenario to which each application combination may apply may be determined based on the target object that were processed by the application combination in the past. For example, when a plurality of application in the past were used to process an image having persons, the application combination generated based on the plurality of applications may be applied to the application scenario of persons. In another example, when a plurality of application in the past were used for processing audios containing music, the application combination generated based on the plurality of applications may be applied to an application scenario of music. When a plurality of application in the past were used for processing audios containing speech recordings, the application combination generated based on the plurality of applications may be applied to an application scenario of recordings.

In another embodiment, the application combination may be generated based on processing contents corresponding to the target object. In the present embodiment, the electronic device may, after determining the type of the target object, automatically adapt a plurality of applications that may be used as the applications for processing the target object based on the contents included in the target object. Automatically adapting the applications based on the contents included in the target object may include automatically adapting the applications based on a to-be-processed portion of the contents included in the target object. Exemplarily, the target object is the image and the image is an image of a person, and the electronic device recognizes that a face of the person in the image needs to be thinned and a color tone of the person needs to be adjusted. In this case, an adapted application may be an application that can perform face thinning and can adjust the color tone. In another example, the target object is the text, and the electronic device recognizes that the text needs to be translated and font sizes of letters are inconsistent. In this case, an adapted application may be an application that can perform translation and can adjust font sizes. In another example, the target object is the audio, and the electronic device recognizes that a length of the audio is greater than a specified length and the audio includes noise. In this case, an adapted application may be an application that can edit the length of the audio and remove the noise.

In an operation S130, at least one application may be selected sequentially one by one from the at least one application, and a corresponding to-be-processed object may be processed by a currently-selected application, an object processing result may be obtained after at least one processing. The to-be-processed object corresponding to an application that is firstly selected may be the target object, and the to-be-processed object corresponding to an application that is not firstly selected may be an objected that is obtained by processing the target object for at least once.

In the present embodiment, the at least one application may be used to process the target object. In the case that a plurality of applications are used to process the target object, the plurality of applications may be used sequentially one by one to perform the object. Therefore, after determining the at least one application for processing the target object, the at least one application may be selected sequentially to process the corresponding to-be-processed object. Selecting the at least one application sequentially one by one to process the corresponding to-be-processed object may be understood as follows. One application may be selected from the at least one application at a time. The currently-selected application may be used to process the corresponding to-be-processed object. After obtaining a post-processed object is obtained, another application may be selected, the selected another application may be used to process the corresponding to-be-processed object. The object processing result may be obtained after a plurality of times of processing are performed.

Furthermore, to be noted that, in the case that the plurality of applications may be configured to process the target object, the plurality of applications perform the processing sequentially. Therefore, the plurality of applications correspond to the to-be-processed objects that are different from each other. For example, the application that is firstly selected may directly process the target object determined as described previously. In contrast, the application which is not firstly selected (the application which is selected after the application which is firstly selected) processes the object which is obtained after the target object is processed. Exemplarily, the at least one application corresponding to the target object includes the application A, the application B, and the application C. When the application that is firstly selected is the application A, the target object may be directly processed by the application A firstly, and a post-processed object output from the application A may be obtained. When the application B is selected afterwards (a second selection), the application B may be used to process the post-processed object outputted from the application A, and a post-processed object output from the application B may be obtained. Subsequently, the application C is selected afterwards (a third selection), the application C may be used to process the post-processed object outputted from the application B, and a post-processed object output from the application C may be obtained. The post-processed object outputted from the application C may be used as the object processing result.

In the present embodiment, the object output from each application may be saved or displayed. The electronic device may take the object output by a last application as the object processing result.

According to the object processing method provided in the present embodiment, after displaying the first processing interface including the target object, the at least one application for processing the target object may be obtained, and the identifier of each of the at least one application may be displayed in the first processing interface. At least one application may be selected sequentially one by one from the at least one application, and the corresponding to-be-processed object may be processed by the currently-selected application. The object processing result may be obtained after at least one processing. In this way, in the case that the target object needs to be processed by the at least one application, the at least one application corresponding to the target object may be collectively obtained, and the at least one application may be collectively displayed on the first processing interface. Therefore, the user may select desired applications to process the target object or the to-be-processed object in the first processing interface. Operations of switching between interfaces of displaying the applications in the electronic device to select a plurality of applications may be avoided, the user may perform operations more conveniently, and the ease of operation may be improved.

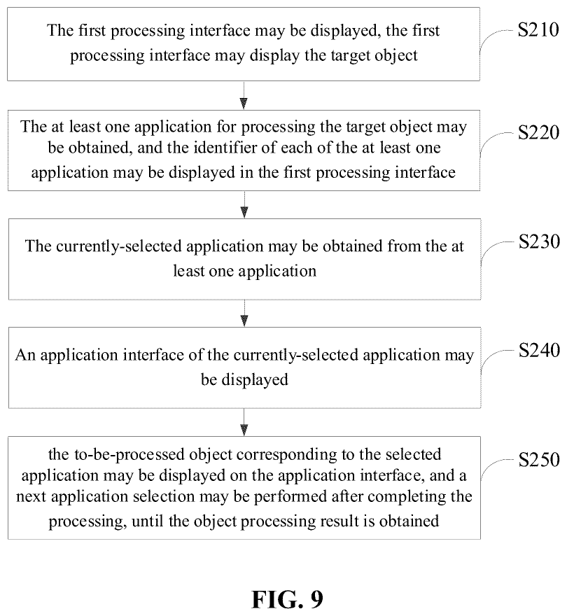

As shown in FIG. 9, an object processing method may be provided by an embodiment and may be performed by the electronic device, the method may include the following.

In an operation S210, the first processing interface may be displayed, the first processing interface may display the target object.

In an operation S220, the at least one application for processing the target object may be obtained, and the identifier of each of the at least one application may be displayed in the first processing interface.

In an operation S230, the currently-selected application may be obtained from the at least one application.

In an operation S240, an application interface of the currently-selected application may be displayed.

The application interface of the currently-selected application may be an interface for performing the target object.

Further, in the case that the application interface is displayed, the target object may be displayed in the application interface. When the target object is the image, an image content of the target object may be directly displayed in the application interface when displaying the target object. When the target object is the text, the text content included or included text content of the target object may be directly displayed in the application interface when displaying the target object. When the target object is the audio, specific audio information included in the audio may be directly displayed in the application interface when displaying the target object. The specific audio information may include sound intensity and a phase of each audio frame.

In an operation S250, the to-be-processed object corresponding to the selected application may be displayed on the application interface, and a next application selection may be performed after completing the processing, until the object processing result is obtained. The to-be-processed object corresponding to the application that is firstly selected may be the target object. The to-be-processed object corresponding to the application that is not firstly selected may be the object obtained after processing the target object for at least once.

In an embodiment, a plurality of editing tools to which the application belongs may be included in the application interface. The user may select a desired editing tool from the plurality of editing tools to process the corresponding to-be-processed image. After completing the processing, the application interface may be closed, and the next application selection may be performed.

In an embodiment, displaying the application interface of the currently-selected application may include: the electronic device switching from displaying the first processing interface to displaying the application interface of the currently-selected application. In the present embodiment, performing the next application selection after completing the processing may include: after completing the processing, the electronic device switching from displaying the application interface to displaying the first processing interface for performing the next application selection. In some embodiments, in response to an export operation performed on the application interface, it is determined that the processing is completed. The export operation is performed to save the object processed through the application interface to the electronic device. In this way, the electronic device may save the post-processed object, and at the same time, may synchronously switch from displaying the application interface to displaying the first processing interface. Therefore, the user may not manually close the application interface or manually open the first processing interface, frequent manual application window (application interface) switching may not be performed during processing the target object through the at least one application.

Exemplarily, the target object may be the image. As shown in a left part of FIG. 10, the at least one application corresponding to the target object may be displayed in the first processing interface 13. As shown in a right part of FIG. 10, when the application A is selected, the electronic device may display an application interface 20 of the application A. Contents of the target image may be displayed in the application interface 20. When the user completes the processing and triggers export of the post-processed object in the application interface 20, the electronic device may save the object in the application interface 20 and switch from displaying contents shown in the right part in FIG. 10 to displaying contents shown in the left part in FIG. 10.

It should be noted that in the present embodiment, the application for processing the object may be selected manually by the user or selected by the electronic device itself from the plurality of applications. When the application for processing the object is selected by the electronic device itself, the first selection of the application may be performed by the user. After detecting that a previous application is completed and switching to displaying the first processing interface, the electronic device may automatically select another application and display a corresponding application interface of the another application.

Each selected application may generate a respective output object. In this case, the object processed by each application may be displayed in the first processing interface.

It is to be noted that the object outputted from the currently-selected application (the post-processed object) may be saved to a designated location in the electronic device, such that enables the a next-selected application may read the to-be-processed object directly from the designated location.

According to the object processing method in the present embodiment, operations of switching between application displaying interfaces in the electronic device for a plurality of times to select the plurality of applications may be avoided, the user may perform operations more conveniently. Moreover, in the present embodiment, in the process of processing the corresponding to-be-processed object by the currently-selected application, the application interface of the currently-selected application may be triggered to be displayed, such that the to-be-processed object may be processed manually by the user through the application interface. Further, when the processing is completed, the electronic device can automatically trigger switching from displaying the application interface to displaying the first processing interface. Operations manually performed by the user to close the application interface and to switch to displaying the first processing interface may be avoided. Therefore, the application interface may be displayed to enable the user to manually process the object, and excessively more operations, due to displaying the application interface, do not need to be performed by the user.

As shown in FIG. 11, the object processing method is provided by an embodiment and may be performed by the electronic device, the method may include the following.

In an operation S310, the first processing interface may be displayed, and the first processing interface may display the target object.

In an operation S320, the at least one application corresponding to the target object may be obtained, and a processing sequence corresponding to the plurality of applications may be obtained, and the plurality of applications may be displayed in the first processing interface.

It is to be noted that, in some cases, the plurality of applications configured to process the target object may have a certain processing order. In order to enable the user to more intuitively feel the processing sequence of the plurality of applications, the plurality of applications may be displayed in the first processing interface based on the processing sequence in which the plurality of applications process the target object.

In an embodiment, the electronic device may, in response to a first trigger operation performed on the first processing interface, display the first application selection interface. The first application selection interface may display to-be-selected applications. The plurality of applications may be selected from the to-be-selected applications as the at least one application corresponding to the target object. A sequence in which the plurality of applications are selected in the first application selection interface may be used as the processing sequence of the plurality of applications. Exemplarily, in the first application selection interface, an application A, an application B, an application C, and an application D may be displayed. The user may firstly select the application A, then select the application B, and then select the application C. In this case, the application A, the application B, and the application C may be determined as the at least one application corresponding to the target object, and the processing sequence may be: the application A performing the processing firstly, the application B performing the processing after the application A, and the application C performing the processing after the application B.

In an operation S330, at least one application may be selected sequentially one by one from the at least one application, and the corresponding to-be-processed object may be processed by the currently-selected application, and the object processing result may be obtained after at least one processing. The to-be-processed object corresponding to the application that is firstly selected may be the target object. The to-be-processed object corresponding to the application that is not firstly selected may be an object outputted by an application which performs the processing earlier than the instant application in the processing sequence.

It should be noted that in the embodiment of determining the processing sequence of the plurality of applications, selection of the plurality of applications may be performed based on the processing sequence of the plurality of applications. Moreover, in this case, the currently-selected application may be configured to process the object output by another application which performs the processing immediately earlier than the currently-selected application in the processing sequence. Exemplarily, the plurality of applications may include an application A, an application B, and an application C. For the application B, the application which performs the processing immediately earlier than the application B in the processing sequence may be the application A. Therefore, when the application B is selected, the corresponding to-be-processed object may be the object output by the application A. For the application C, the application which performs the processing immediately earlier than the application C in the processing sequence may be the application B. Therefore, when the application C is selected, the corresponding to-be-processed object may be the object output by the application B.

It should be noted that in the present embodiment, when the application outputs the object (the post-processed object), corresponding application information may be configured synchronously for the output object. The application information may be configured to represent by which application the output object was processed and output. In this case, the currently-selected application may select the corresponding to-be-processed object based on the application information. For example, when non-first application selection is being performed, after determining the currently-selected application, target application information may be determined firstly. An application represented by the target application information may perform the processing earlier than the currently-selected application in the processing sequence. The to-be-processed object corresponding to the target application information may be taken as the to-be-processed object corresponding to the currently-selected application

According to the object processing method in the present embodiment, operations of switching between application displaying interfaces in the electronic device for a plurality of times to select the plurality of applications may be avoided, the user may perform operations more conveniently. Moreover, in the present embodiment, in addition to obtaining the plurality of applications, the processing sequence of the plurality of applications may also be synchronously obtained. Therefore, after beginning processing the target object, respective to-be-processed objects may be processed according to the processing sequence of the plurality of applications. In this way, the user may have better understanding of each current processing stage. Furthermore, in the present embodiment, the object output by each application may be displayed, and a display sequence may be consistent with the processing sequence of the plurality of applications. Therefore, the user may more intuitively understand by which application each object is processed.

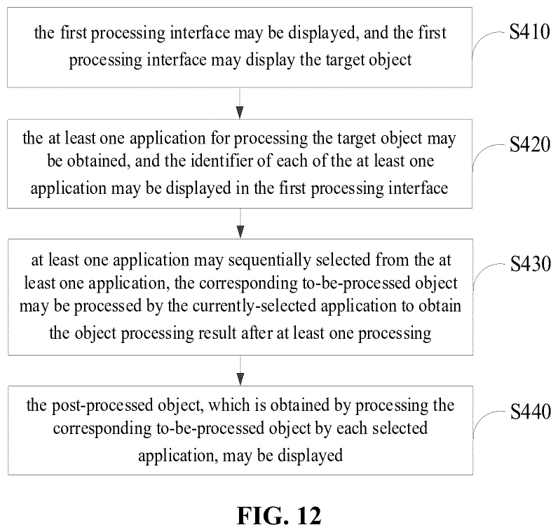

As shown in FIG. 12, the object processing method is provided by an embodiment and may be performed by the electronic device, the method may include the following.

In an operation S410, the first processing interface may be displayed, and the first processing interface may display the target object

In an operation S420, the at least one application for processing the target object may be obtained, and the identifier of each of the at least one application may be displayed in the first processing interface.

In an operation S430, at least one application may sequentially selected from the at least one application, the corresponding to-be-processed object may be processed by the currently-selected application to obtain the object processing result after at least one processing. The to-be-processed object corresponding to the application that is firstly selected may be the target object, and the to-be-processed object corresponding to the application that is not firstly selected may be the object obtained after processing the target object for at least once.

In an operation S440, the post-processed object, which is obtained by processing the corresponding to-be-processed object by each selected application, may be displayed.

By displaying the post-processed object output by each selected application, the user may compare a plurality of post-processed objects. In an embodiment, the plurality of applications may have the processing sequence. Displaying the post-processed object obtained after processing the corresponding to-be-processed object by each selected application may include: displaying, in a stacked manner, post-processed objects obtained after processing the corresponding to-be-processed objects by the plurality of selected applications. A post-processed object output by the application that performs the processing at a later stage may be displayed at a higher layer of the stack than a post-processed object output by the application that performs the processing at an earlier stage.

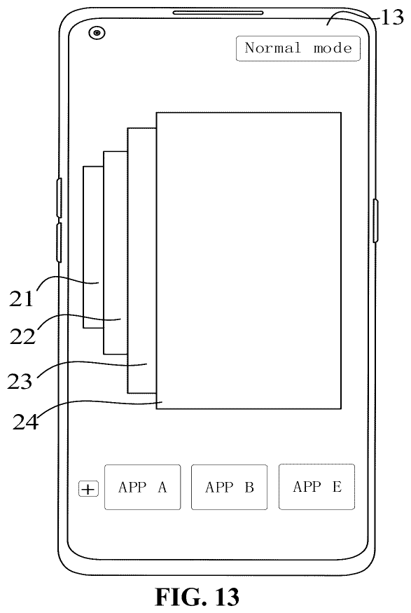

Exemplarily, the target object may be the image. As shown in FIG. 13, the target object 21, a post-processed object 22, a post-processed object 23, and a post-processed object 24 may be displayed in the first processing interface 13. The post-processed object 22 may be output by the application A after processing the target object 21. The post-processed object 23 may be output by the application B after processing the target object 22. The post-processed object 24 may be output by application C after processing the target object 23. The application A may perform the processing earliest in the processing sequence, the application B may perform the processing after the application A in the processing sequence, and the application C may perform the processing after the application B in the processing sequence.

In some embodiments, when a dragging operation performed on the post-processed object is detected and the dragging operation satisfies a target condition. The post-processed object receiving the dragging operation may be displayed side-by-side with another post-processed object generated earlier than the post-processed object receiving the dragging operation.

An icon of a first application and an icon of a second application may be enlarged to be displayed. The first application may be an application that outputs the post-processed object receiving the dragging operation, and the second application may be an application that outputs the post-processed object generated earlier than the post-processed object receiving the dragging operation.

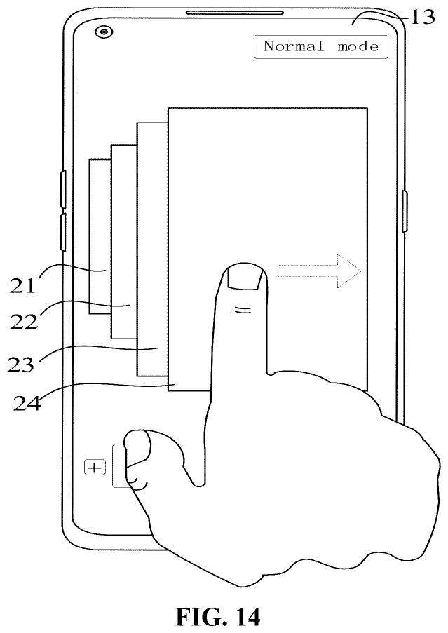

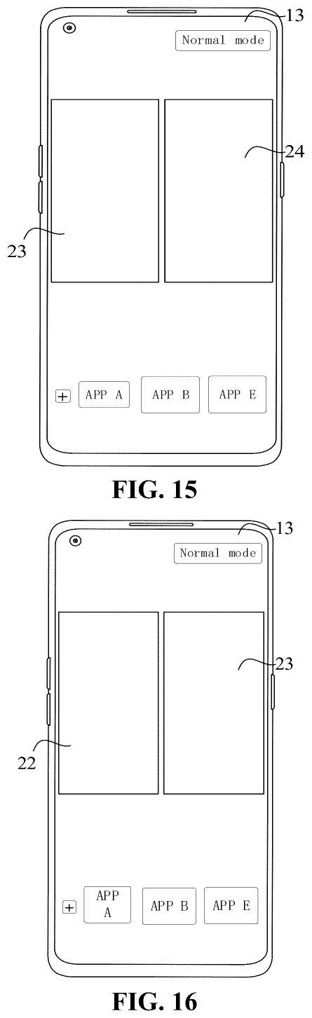

Exemplarily, as shown in FIG. 14, when the dragging operation performed on the post-processed object 24 is detected and the dragging operation may be performed in a direction indicated by a dashed arrow in FIG. 14, it may be determined that the target condition is satisfied. The post-processed object 23, which is corresponding to the post-processed object 24 and is generated earlier than the post-processed object 23 may be obtained. Subsequently, the post-processed object 24 and the post-processed object 23 may be displayed side by side as shown in FIG. 15. Moreover, the post-processed object 23 may be output by the application B, and the post-processed object 24 may be output by the application C. In this case, the icon corresponding to the application B and the icon corresponding to the application C may be enlarged to be displayed.

In a process of comparing the post-processed object 24 and the post-processed object 23, when it is determined that a processing effect of the post-processed object is not satisfied, the user may click on the application B, and the application interface of the application B may be triggered to be displayed again. The post-processed object 22 may be displayed in the application interface of the application B. After the application B completed the processing, a post-processed object may be output by the application B to replace the post-processed object 23.

Further, in the case that the first processing interface 13 is shown in FIG. 15, when the dragging operation is continued to be performed on the post-processed object 23 and the dragging operation satisfies the target condition, the post-processed object 22, which is corresponding to the post-processed object 23 and is generated earlier than the post-processed object 23, may be obtained. In this way, the post-processed object 23 and the post-processed object 22 may be displayed side by side as shown in FIG. 16.

According to the object processing method in the present embodiment, operations of switching between application displaying interfaces in the electronic device for a plurality of times to select the plurality of applications may be avoided, the user may perform operations more conveniently. Moreover, in the present embodiment, the post-processed object obtained by processing of each selected application may be displayed. Moreover, in the case that a plurality of post-processed objects are displayed, at least two post-processed images may be triggered to be displayed side by side by the dragging operation, such that the user may perform comparison.

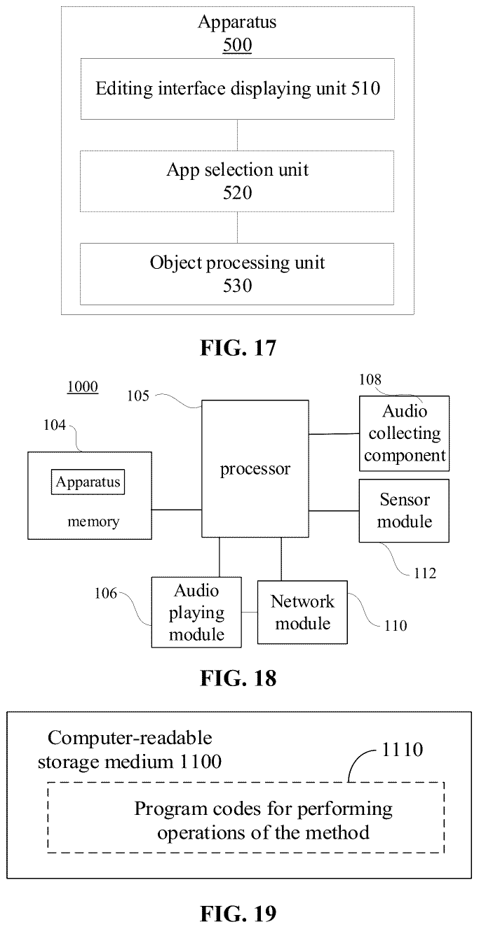

As shown in FIG. 17, an object processing apparatus 500 is provided by an embodiment and may be run in the electronic device, and the object processing apparatus 500 may include the following.

An editing interface display unit 510 may be configured to display the first processing interface, and the first processing interface may display the target object.

In an embodiment, the editing interface display unit 510 may be configured to: display objects in an object collection; obtain the object selected from the object collection as the target image; and display the target object displaying interface corresponding to the target object; and display the first processing interface by performing the interface startup operation on the target object displaying interface.

An application selection unit 520 may be configured to obtain the at least one application for processing the target object, and display the identifier of each of the at least one application in the first processing interface.

The object processing unit 530 may be configured to: sequentially select at least one application from the at least one application; use the currently-selected application to process the corresponding to-be-processed object to obtain the object processing result after at least one processing. The to-be-processed object corresponding to the application that is firstly selected may be the target object, and the to-be-processed object corresponding to the application that is not firstly selected may be the object that is obtained after processing the target object for at least once.

In an embodiment, the object processing unit 530 may be configured to: obtain, from the plurality of applications, the currently-selected application; display an application interface of the currently-selected application; process the to-be-processed object corresponding to the currently-selected application through the application interface; perform the next application selection after completing the processing, until the object processing result being obtained. In some embodiments, the object processing unit 530 may be configured to: switch from displaying the first processing interface to displaying the application interface of the currently-selected application; and switch, after the processing being completed, from displaying the application interface to displaying the first processing interface to perform the next application selection. In some embodiments, the object processing unit 530 may be configured to determine, in response to the export operation being performed on the application interface, that the processing is completed. The export operation may be configured to save the object processed through the application interface to the electronic device.

In an embodiment, the application selection unit 520 may be configured to: obtain the at least one application corresponding to the target object and the processing sequence of the plurality of applications. The to-be-processed object corresponding to the application that is not firstly selected may be the object outputted from the application which performs the processing earlier than the currently-selected application in the processing sequence.

In an embodiment, the application selection unit 520 may be configured to: display, in response to the first trigger operation performed on the first processing interface, the first application selection interface which displays to-be-selected applications; obtain the plurality of applications selected from the to-be-selected applications as the at least one application corresponding to the target object; and use the sequence in which the plurality of applications are selected in the first application selection interface as the processing sequence of the plurality of applications.

In an embodiment, the application selection unit 520 may be configured to: display, in response to the second trigger operation performed on the first processing interface, the second application selection interface which displays the plurality of application combinations; use the plurality of applications included in the selected application combination as the at least one application corresponding to the target object. In some embodiments, the plurality of application combinations may be generated based on the plurality of applications that were selected in the past or based on the processing contents corresponding to the target object.

In an embodiment, the object processing unit 530 may be configured to display the post-processed object, which is obtained by processing the corresponding to-be-processed object by each selected application. In some embodiments, the plurality of applications have the processing sequence. The object processing unit 530 may be configured to display, in a stacked manner, the post-processed objects obtained after the corresponding to-be-processed objects being processed by the plurality of selected applications. The post-processed object output from the application that performs the processing at a later stage in the processing sequence may be displayed at a higher layer of the stack. The object processing unit 530 may be configured to: display, in response to detecting the dragging operation performed on the post-processed object and the dragging operation satisfying the target condition, the post-processed object receiving the dragging operation side by side with the post-processed object generated before the post-processed object receiving the dragging operation; display the enlarged icon of the first application and the enlarged icon of the second application. The first application may be the application outputting the post-processed object receiving the dragging operation, the second application may be the application outputting the post-processed object generated before the post-processed object receiving the dragging operation.

According to the object processing apparatus in the present embodiment, when the target object needs to be processed by at least one application, the at least one application corresponding to the target object may be collectively obtained. The at least one application may be collectively displayed directly through the first processing interface. The user may select the desired plurality of applications in the first processing interface to process the target object. Operations of switching between application displaying interfaces in the electronic device for a plurality of times to select the plurality of applications may be avoided, the user may perform operations more conveniently.

To be noted that the apparatus embodiments and the aforementioned method embodiments in the present disclosure correspond to each other, and specific principles in the apparatus embodiments may be referred to the aforementioned method embodiments, which will not be repeated herein.

An electronic device is provided in the present disclosure and will be described below by referring to FIG. 18.

As shown in FIG. 18, based on the above-described object processing method, the present disclosure further provides an electronic device 1000 that can perform the above-described object processing method. The electronic device 1000 may include one or more (only one is shown in the drawings) processors 105, a memory 104, an audio playing module 106, and an audio capturing component 108, which are coupled with each other. The memory 104 may have store programs that can execute the method of the preceding embodiments, and the processor 105 may execute the programs stored in the memory 104.

The processor 105 may include one or more processing cores. The processor 105 may use various interfaces and wires to connect various components in the entire electronic device 1000 to each other to perform various functions and to process data of the electronic device 1000 by running or executing instructions, programs, code sets, or instruction sets stored in the memory 104, and by invoking data stored in the memory 104. In some embodiments, the processor 105 may be configured in at least one form of hardware of: a digital signal processing (DSP), a field-programmable gate array (FPGA), a programmable logic array (PLA). The processor 105 may integrate one or a combination of: a central processing unit (CPU), a graphics processing unit (GPU), and a modem. The CPU substantially processes an operating system, user interfaces and applications. The GPU may substantially be configured to render and draw displaying contents. The modem may be configured to process wireless communication. It is to be understood that the above modem may not be integrated into the processor 105, and may be configured as an independent communication chip alone.

The memory 104 may include a Random Access Memory (RAM) or a read-only memory (ROM). The memory 104 may be used to store instructions, programs, codes, code sets, or instruction sets. For example, an apparatus may be stored in the memory 104. The apparatus may be the aforementioned apparatus 500. The memory 104 may include a storage program area and a storage data area. The storage program area may store instructions for implementing the operating system, instructions for implementing at least one function (such as a touch function, a sound playing function, an image displaying function, and so on), instructions for implementing each of the method embodiments described below.

Further, the electronic device 1000 may include a network module 110 and a sensor module 112 in addition to the components described in the above.

The network module 110 may be configured to achieve information interaction between the electronic device 1000 and other devices, such as to achieve connection establishment with other audio playing devices or other electronic devices, and to achieve information interaction based on the established connection. In an embodiment, the network module 110 of the electronic device 1000 may be a radio frequency module, which is configured to receive and transmit electromagnetic waves, so as to achieve mutual conversion of electromagnetic waves and electrical signals, such that the electronic device 1000 may communicate with a communication network or other devices. The radio frequency module may include various circuit elements in the art for performing these functions, such as, an antenna, a radio frequency transceiver, a digital signal processor, an encryption/decryption chip, a subscriber identity module (SIM) card, a memory, and the like. For example, the radio frequency module may interact with an external device by sending or receiving electromagnetic waves.

The sensor module 112 may include at least one type of sensor. Specifically, the sensor module 112 may include, but is not limited to: a pressure sensor, a motion sensor, an acceleration sensor, and other sensors. The pressure sensor may be a sensor that detects pressure generated by pressing on the electronic device 1000. That is, the pressure sensor may detect pressure generated by a contact or pressing between the user and the electronic device 1000, such as pressure generated by a contact or pressing between an ear of the user and the electronic device 1000. Therefore, the pressure sensor may be configured to determine whether the contact or pressing is generated between the user and the electronic device 1000, and determine a magnitude of the pressure.

The acceleration sensor may detect a magnitude of acceleration in each direction (generally in each of three axes), and may detect a magnitude and a direction of gravity at rest. The acceleration sensor may be configured for applications that recognize an attitude of the electronic device 1000 (such as landscape/portrait screen switching, related games, magnetometer attitude calibration), and vibration recognition related functions (such as pedometers, tapping), and the like. In addition, the electronic device 1000 may be configured with other sensors such as a gyroscope, a barometer, a hygrometer, a thermometer, and so on, which will not be described herein.

An audio obtaining component 110 may be configured to collect audio signals. In some embodiments, the audio obtaining component 110 may include a plurality of audio collecting elements, which may be microphones.

As shown in FIG. 19, FIG. 19 is a schematic view of a storage unit configured to store or carry program codes of the object processing method according to an embodiment of the present disclosure. The computer-readable storage medium 1100 may store program codes. The program codes may be invoked by a processor to execute the method described in the above embodiments.

The computer-readable storage medium 1100 may be an electronic memory such as a flash memory, an electrically erasable programmable read-only memory (EEPROM), an EPROM, a hard disk, or a ROM. In some embodiments, the computer-readable storage medium 1100 may include a non-volatile computer-readable medium. The computer-readable storage medium 1100 may have a storage space for program codes 1110 that perform any of the steps in the method described above. The program codes may be read from or written to one or more computer program products. The program codes 1110 may, for example, be compressed in an appropriate form.

In summary, the present disclosure provides the object processing method, the apparatus, the electronic device, and the computer-readable storage medium. After displaying the first processing interface including the target object, the at least one application for processing the target object may be obtained, and the identifier of each of the at least one application may be displayed in the first processing interface. At least one application may be sequentially selected from the at least one application. The corresponding to-be-processed object may be processed by the currently-selected application to obtain the object processing result after at least one processing. Therefore, in the case that the target object needs to be processed by at least one application, the at least one application corresponding to the target object may be collectively obtained firstly, and then the at least one application may be centrally displayed directly through the first processing interface. In this way, the user may select the desired application to process the target object or the to-be-processed object on the first processing interface. Operations of switching between application displaying interfaces in the electronic device for a plurality of times to select the plurality of applications may be avoided, the user may perform operations more conveniently.

Finally, it should be noted that the above embodiments are only described to illustrate technical solutions of the present disclosure, but not to limit the technical solutions. Although the present disclosure is described in detail based on the foregoing embodiments, any ordinary skilled person in the art shall understand that the technical solutions as recorded in the above embodiments may be modified, or equivalent replacements may be made for some of the technical features. The modifications or replacements do not cause corresponding technical solutions to depart from the essence of the technical solutions of the present disclosure.

1. An object processing method, performed by an electronic device, the method comprising:
displaying a first processing interface, wherein the first processing interface displays a target object;
obtaining at least one application configured to process the target object, and displaying an identifier of each of the at least one application in the first processing interface;
sequentially selecting at least one application from the at least one application and processing a corresponding to-be-processed object by each currently-selected application to obtain an object processing result after at least one processing; wherein the to-be-processed object corresponding to an application that is firstly selected from the at least one application is the target object; the to-be-processed object corresponding to an application that is not firstly selected from the at least one application is an object obtained after processing the target object for at least once.

2. The object processing method according to claim 1, wherein the sequentially selecting at least one application from the at least one application and processing a corresponding to-be-processed object by each currently-selected application to obtain an object processing result after at least one processing, comprises:
obtaining the currently-selected application from the at least one application;
displaying an application interface of the currently-selected application;
processing the to-be-processed object corresponding to the currently-selected application through the application interface; performing a next application selection after the currently-selected application completing processing, until the object processing result being obtained.

3. The object processing method according to claim 2, wherein,
the displaying an application interface of the currently-selected application comprises:
switching from displaying the first processing interface to displaying the application interface of the currently-selected application; and
the performing a next application selection after the currently-selected application completing processing, comprises:
switching, after the processing being completed, from displaying the application interface to displaying the first processing interface to perform the next application selection.

4. The object processing method according to claim 3, further comprising:
determining, in response to an export operation being performed on the application interface, that the processing is completed, wherein the export operation is configured to save an object processed through the application interface to the electronic device.

5. The object processing method according to claim 1, wherein the obtaining at least one application configured to process the target object comprises:
obtaining at least one application configured to process the target object and a corresponding processing sequence of a plurality of applications of the at least one application;
wherein the to-be-processed object corresponding to an application that is not firstly selected from the at least one application is an object output by one of the at least one application which performs the processing earlier than the currently-selected application.

6. The object processing method according to claim 5, wherein the obtaining at least one application configured to process the target object and a corresponding processing sequence of a plurality of applications of the at least one application, comprises:
displaying a first application selection interface in response to a first trigger operation performed on the first processing interface, wherein the first application selection interface displays to-be-selected applications;
obtaining a plurality of applications selected from the to-be-selected applications as the at least one application corresponding to the target object;
using a sequence in which the plurality of applications are selected in the first application selection interface as the processing sequence of the plurality of applications.

7. The object processing method according to claim 1, wherein the obtaining at least one application configured to process the target object comprises:
displaying, in response to a second trigger operation performed on the first processing interface, a second application selection interface, wherein the second application selection interface displays a plurality of application combinations;
using a plurality of applications comprised in an application combination selected from the plurality of application combinations as the at least one application corresponding to the target object.

8. The object processing method according to claim 7, further comprising:
generating the plurality of application combinations based on a plurality of applications that were selected in a past; or
generating the plurality of application combinations based on processing contents corresponding to the target object.

9. The object processing method according to claim 7, further comprising:
displaying an application scenario to which each of the plurality of application combinations applies.

10. The object processing method according to claim 1, wherein the displaying an identifier of each of the at least one application in the first processing interface comprises:
displaying the at least one application in the first processing interface based on a processing sequence in which the at least one application processes the target object.

11. The object processing method according to claim 1, wherein an object type of the target object is an image, the method further comprises:
displaying a post-processed object obtained by processing the corresponding to-be-processed object by each of the selected at least one application.

12. The object processing method according to claim 11, wherein the at least one application configured to process the target object comprises a plurality of applications, and the plurality of applications have a processing sequence; and the displaying a post-processed object obtained by processing the corresponding to-be-processed object by each of the selected at least one application, comprises:
displaying, in a stacked manner, post-processed objects obtained after processing corresponding to-be-processed objects by the plurality of applications; wherein a post-processed object obtained by one of the plurality of applications that performs the processing at a later stage is displayed at a higher layer of a stack.

13. The object processing method according to claim 12, further comprising:
in response to a dragging operation performed on the post-processed object being detected and the dragging operation satisfying a target condition, displaying the post-processed object receiving the dragging operation side by side with another post-processed object generated earlier than the post-processed object receiving the dragging operation;
displaying an enlarged icon of a first application and an enlarged icon of a second application; wherein the first application is an application that outputs the post-processed object receiving the dragging operation, and the second application is an application that outputs the another post-processed object generated earlier than the post-processed object receiving the dragging operation.

14. The object processing method according to claim 1, wherein the displaying a first processing interface comprises:
displaying objects in an object collection;
obtaining an object selected from the object collection as the target image and displaying a target object displaying interface corresponding to the target object;
displaying the first processing interface by performing an interface startup operation on the target object displaying interface.

15. The object processing method according to claim 1, wherein the displaying a first processing interface comprises:
displaying a first processing interface that comprises an object adding control;
displaying an object selection interface in a case that a click operation performed on the object adding control is detected, wherein the object selection interface displays a to-be-selected object;
obtaining the target object selected from the object selection interface and displaying the selected target object in the first processing interface.

16. The object processing method according to claim 1, wherein an object type of the target object is an image, and an object type of the to-be-processed object is an image.

17. The object processing method according to claim 1, wherein an object type of the target object is a text or an audio.

18. (canceled)

19. An electronic device, comprising: one or more processors and a memory; wherein one or more programs are stored in the memory and are configured to be executed by the one or more processors to perform operations of:
displaying a first processing interface, wherein the first processing interface displays a target object;
obtaining at least one application configured to process the target object, and displaying an identifier of each of the at least one application in the first processing interface;
sequentially selecting at least one application from the at least one application and processing a corresponding to-be-processed object by each currently-selected application to obtain an object processing result after at least one processing; wherein the to-be-processed object corresponding to an application that is firstly selected from the at least one application is the target object; the to-be-processed object corresponding to an application that is not firstly selected from the at least one application is an object obtained after processing the target object for at least once.

20. A computer-readable storage medium, having program codes stored therein, wherein the program codes are configured to be run by a processor to perform operations of:
displaying a first processing interface, wherein the first processing interface displays a target object;
obtaining at least one application configured to process the target object, and displaying an identifier of each of the at least one application in the first processing interface;
sequentially selecting at least one application from the at least one application and processing a corresponding to-be-processed object by each currently-selected application to obtain an object processing result after at least one processing; wherein the to-be-processed object corresponding to an application that is firstly selected from the at least one application is the target object; the to-be-processed object corresponding to an application that is not firstly selected from the at least one application is an object obtained after processing the target object for at least once.

21. The electronic device according to claim 19, wherein the sequentially selecting at least one application from the at least one application and processing a corresponding to-be-processed object by each currently-selected application to obtain an object processing result after at least one processing, comprises:
obtaining the currently-selected application from the at least one application;
displaying an application interface of the currently-selected application;
processing the to-be-processed object corresponding to the currently-selected application through the application interface; performing a next application selection after the currently-selected application completing processing, until the object processing result being obtained.
